(19) United States
(12) Patent Application Publication
(10) Pub. No.: US 2026/0349176 A1
(43) Pub. Date: Nov. 5, 2026

(54) HIGH PERFORMANCE AND YIELD FOR PASSIVE ALIGNMENT OF OPTICAL FIBERS

(71) Applicant: Photonect Interconnect Solutions, Inc., Rochester, NY (US)

(72) Inventors: Juniyali NAURIYAL, Rochester, NY (US); Sushant KUMAR, Rochester, NY (US); Jaime CARDENAS, Rochester, NY (US)

(21) Appl. No.: 19/130,930

(22) PCT Filed: Nov. 17, 2023
(86) PCT No.: PCT/US2023/080357

§ 371 Date: May 16, 2025

Related U.S. Application Data
(60) Provisional application No. 63/384,575, filed on Nov. 21, 2022.

(51) Int. Cl. G02B 6/14; G02B 6/136

(52) U.S. Cl. CPC G02B 6/14; G02B 6/136

(57) ABSTRACT

The disclosed technology improves the performance and tolerance of photonic devices that include V-grooves for passive alignment of optical fibers to nanowaveguides of the photonic devices. According to aspects of the disclosed technology, oxide mode converters are included in a photonic device to enclose or overlay nanowaveguides. The oxide mode converters serve as an enlarged connection point for an optical fiber sitting in a V-groove, improving misalignment tolerances of the device. Further, the oxide mode converters are configured to match transverse optical modes between the nanowaveguides and the fibers, thereby increasing the performance of the device. Said improvements increase an overall yield of photonic devices, as fewer photonic devices with improper fiber alignment are discarded.

### CROSS-REFERENCE TO RELATED APPLICATIONS

This application claims priority to and the benefit of U.S. Provisional Application No. 63/384,575 titled “HIGH PERFORMANCE AND YIELD FOR PASSIVE ALIGNMENT OF OPTICAL FIBERS” filed on Nov. 21, 2022, the contents of which are incorporated herein by reference in their entirety.

### TECHNICAL FIELD

This patent document generally relates to the field of optics and photonics.

### BACKGROUND

Integrated photonic devices communicate with other devices or components via optical fibers through which light-based signals are transmitted. Some existing devices include V-grooves that are designed to passively align fibers to connection points on a device. In particular, a V-groove is located at an end of a device and defines a cavity in which a fiber securely sits. V-grooves have a very tight misalignment tolerance and can decrease the performance of the device.

### SUMMARY

The disclosed technology relates to methods and devices which, among other features and benefits, improve the performance of photonic devices that include V-grooves by allowing passive alignment of optical fibers to nanowaveguides of the photonic devices with improved misalignment tolerance. Embodiments of the disclosed technology improve mode matching or coupling of optical fibers with photonic devices. According to aspects of the disclosed technology, oxide mode converters are included in a photonic device to enclose or overlay nanowaveguides. The oxide mode converters serve as an enlarged connection point for an optical fiber sitting in a V-groove, improving misalignment tolerances of the device. Further, the oxide mode converters are configured to match transverse optical modes between the nanowaveguides and the fibers, thereby increasing the performance of the device. Said improvements increase an overall yield of photonic devices, as fewer photonic devices with improper fiber alignment are discarded.

The subject matter described in this patent document can be implemented in specific ways that provide one or more of the following features.

### BRIEF DESCRIPTION OF THE DRAWINGS

FIG. 1 illustrates a first partial side view of an example photonic device that includes V-grooves for passive alignment of optical fibers, in accordance with various embodiments described herein.

FIG. 2 illustrates a first partial side view of an example photonic device that includes mode converters that improve the passive alignment and optical connection with optical fibers sitting in V-grooves of the photonic device, in accordance with various embodiments described herein.

FIG. 3 illustrates a second partial side view of an example photonic device that includes a mode converter that improves the passive alignment and optical connection between a nanowaveguides of the photonic device and an optical fiber sitting in a V-groove of the photonic device, in accordance with various embodiments described herein.

FIG. 4 illustrates a top view of a portion of an example photonic device that includes mode converters that improve the passive alignment and optical connection with optical fibers sitting in V-grooves of the photonic device, in accordance with various embodiments described herein.

FIG. 5 illustrates a perspective view of an example mode converter that improves passive alignment and optical connection between a nanowaveguides and an optical fiber, in accordance with various embodiments described herein.

FIG. 6 includes an image of an example mode converter that is configured to improve passive alignment and optical connection between nanowaveguides of a photonic device with optical fibers, in accordance with various embodiments described herein.

FIG. 7 is a flowchart of example operations for fabricating an example photonic device with improved passive alignment and optical connection with optical fibers, in accordance with various embodiments described herein.

### DETAILED DESCRIPTION

The disclosed technology includes photonic devices having mode converters in order to improve passive alignment and optical connection between the photonic devices and optical fibers. The disclosed technology provides mode matching or coupling between the photonic devices (or waveguides thereof) and the optical fibers. Example embodiments increase misalignment tolerances of photonic devices, increase an overall yield of photonic devices, and improve performance of photonic devices.

V-grooves are included in some photonic devices as a means for passive alignment of optical fibers to connection points of a photonic device. With respect to a transverse cross-section, a V-groove is defined by angled walls etched into a depth of a substrate, thus forming a “V” shape. An optical fiber then sits in a V-groove, with the fiber being supported by the angled walls.

V-grooves are etched at connection points of a photonic device, including points or locations where nanowaveguides are provided, so that fibers that sit in the V-grooves meet the connection points of the photonic device. A V-groove must be etched to realize a particular angle and depth such that when a fiber of a particular diameter or circular cross-section is positioned on the V-groove, the fiber aligns with an end of a waveguide (e.g., a nanowaveguide) disposed at an end of the V-groove. However, etching imperfections and inaccurate design commonly result in misalignment of the fiber with the end of a nanowaveguide. Indeed, V-grooves are associated with tight misalignment tolerances, as slight changes to V-groove shape can significantly affect how an optical fiber sits relative to the end of the nanowaveguide. Whenever a photonic device includes V-grooves and experiences significant misalignment defects, the photonic device is discarded in production. Also, fiber attachment is performed towards an end of a production process, and failure of a photonic device to meet certain loss thresholds due to V-groove misalignments is detected at a late stage. Thus, due to tight misalignment tolerances associated with V-grooves, an overall yield of photonic devices in the market suffers.

Aspects of the disclosed technology improve the performance and tolerance of photonic devices that include V-grooves. According to example embodiments, a photonic device includes mode converters that overlay or enclose the end of waveguides disposed at an end of a V-groove. In some embodiments, the mode converters are provided by oxide tapers surrounding the nanowaveguide end.

A mode converter around a nanowaveguide end provides technical benefits on at least two fronts. The mode converter provides a larger connection point with an optical fiber, as compared to the connection point represented by the cross-section of the nanowaveguide end. In some examples, ends of nanowaveguides are on the scale of nanometers across. By contrast, optical fibers have cross-sections or diameters on the scale of micrometers. With the larger connection point provided by the mode converter, misalignment tolerance between an optical fiber and a photonic device is increased.

Further, mode converters that are disposed between nanowaveguide ends and optical fibers sitting in V-grooves improve the performance of photonic devices by improving the optical connection between the nanowaveguide ends and optical fibers. According to example embodiments, the mode converters match the transverse optical mode of an optical fiber to the transverse optical mode of the nanowaveguide end. Thus, the mode converters optically/modally couple fiber ends with nanowaveguides ends. By doing so, an amount of power and coupling efficiency that is lost between nanowaveguides and optical fibers is reduced.

By the technical benefits provided by introducing mode converters between the nanowaveguide ends of a photonic device and the ends of optical fibers sitting in V-grooves, performance and scalability of photonic devices are improved. On a larger scale, production yield of photonic devices is increased. In particular, less photonic devices experience misalignments and unacceptable performance losses, and less photonic devices are discarded.

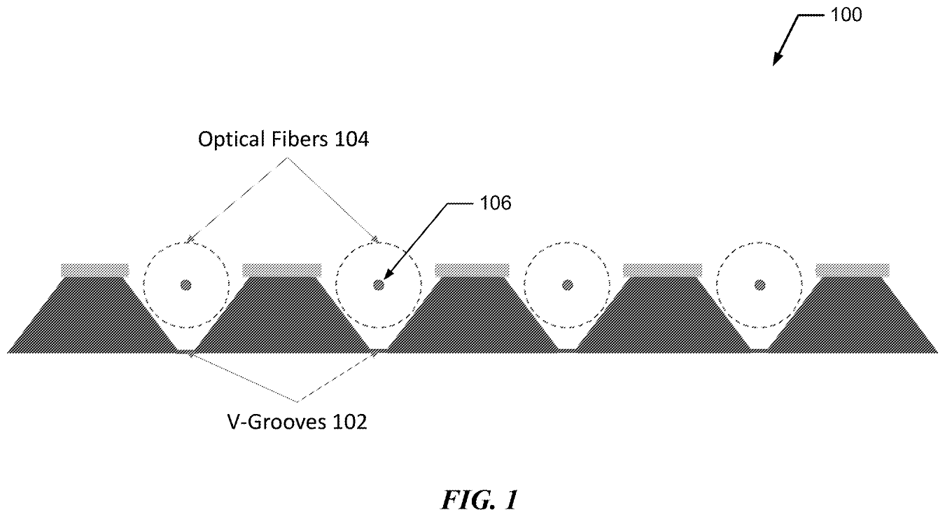

FIG. 1 illustrates a partial side view of an example photonic device 100. A plane of the partial side view shown in FIG. 1 is transverse to a length of V-grooves 102 of the photonic device 100.

As used herein, photonic devices include photonic chips, photonic circuits, integrated optical circuits, integrated optical devices or components, and/or the like.

As illustrated in FIG. 1, an example photonic device 100 includes a plurality of V-grooves 102 configured to provide passive alignment for fibers with the photonic device 100. Each V-groove 102 corresponds to a connection point of the photonic device 100, for example, a nanowaveguide from which the photonic device 100 transmits and receives light-based signals. A nanowaveguide (not explicitly illustrated) is located at the end of the V-groove 102. An optical fiber 104 that is disposed within the V-groove 102 can be passively aligned with the nanowaveguide at the V-groove 102. For example, a fiber array of multiple optical fibers slides into the V-grooves 102 of the photonic device 100.

As identified above, V-grooves 102 are associated with tight misalignment tolerances. For example, variations in the angle of the angle walls of a V-groove 102 can cause an optical fiber 104 to sit higher, sit lower, sit skewed, and/or the like within the V-groove 102. In such example instances, a fiber core 106 of the optical fiber 104 fails to align with the nanowaveguide of the photonic device 100, leading to link losses. Similarly, use of an optical fiber 104 that has a different cross-section shape or size than intended for a given V-groove results in unintended positioning and misalignment of the fiber core 106 of the optical fiber 104 within the given V-groove. That is, a V-groove 102 is specifically fabricated for optical fibers 104 of a certain cross-sectional shape and/or size. As stated, these technical challenges related to V-grooves 102 lead to photonic devices being discarded in production.

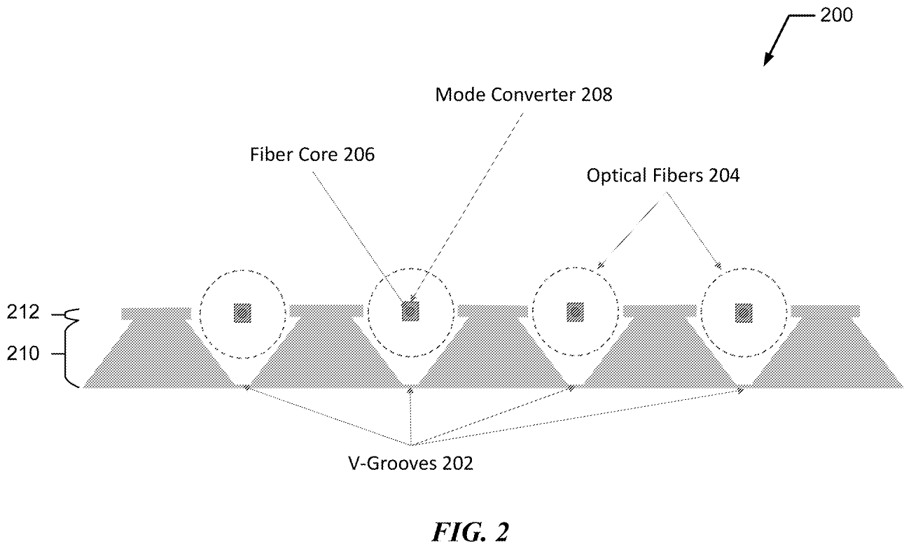

FIG. 2 illustrates a partial side view of an example photonic device 200 that includes mode converters for improving passive alignment and optical connection with optical fibers. A plane of the partial side view shown in FIG. 2 is transverse to a length of V-grooves 202 of the photonic device 200.

As illustrated in the FIG. 2, the photonic device 200 includes a plurality of V-grooves 202 for passive alignment of optical fibers 204 each having fiber core 206 (and cladding surrounding the fiber core 206). In some embodiments, the optical fibers 204 include single-mode fibers and/or multi-mode fibers. In some embodiments, a V-groove 202 extends into a depth of a substrate layer 210 of the photonic device 200. For example, the substrate layer 210 is a silicon substrate, and the substrate layer 210 is composed of any suitable or typical material for photonic device substrates, including silicon, fused silica, glass, quartz, sapphire, gallium arsenide, indium phosphide, silicon carbide, diamond, lithium niobate, and/or the like. Above the substrate layer 210, the photonic device 200 includes an oxide layer 212, and in some embodiments, the oxide layer 212 is composed of suitable material including silicon dioxide, glass, doped glass, fluoride glasses, silicon nitride, and/or semiconductor materials. As shown, a V-groove 202 is etched past the oxide layer 212 into the substrate layer 210. In some embodiments, the oxide layer 212 is deposited onto the substrate layer 210 after the V-grooves 202 are formed (e.g., etched) into the substrate layer 210. In some embodiments, the oxide layer 212 is a cladding layer in which the nanowaveguides are disposed and is configured to act as cladding for the nanowaveguides (e.g., based on a refractive index configured with respect to an index of the nanowaveguides). As such, in some embodiments, silicon dioxide modes are not adiabatically excited.

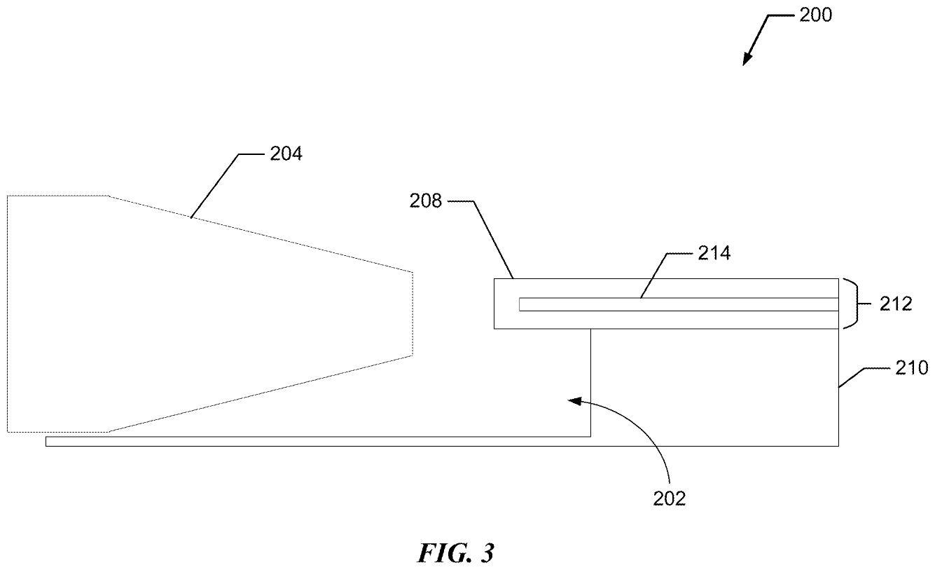

According to example embodiments, the photonic device 200 includes a plurality of mode converters 208, and each mode converter 208 corresponds to a nanowaveguide located at a V-groove 202. In some embodiments, a mode converter 208 is part of the oxide layer 212 and is composed of a same material as the oxide layer 212. For example, a mode converter 208 is an oxide feature that surround, overlays, or encloses a nanowaveguide that is disposed below, atop, or within the oxide layer 212 (FIG. 3 provides further details with a more complete illustration of an example mode converter that is formed as part of an oxide layer). In the illustrated example of FIG. 3, the mode converters 208 have rectangular or trapezoidal cross-sections, while the optical fiber 204 and the fiber cores 206 have circular cross-sections. It will be appreciated by those of skill in the field that other cross-sectional shapes, in either the plane represented by the view in FIG. 3 or the plane represented by the view in FIG. 2, can be implemented for at least the mode converters 208, including triangular cross-sections, circular cross-sections, hexagonal cross-sections, and/or the like.

With the mode converters 208, passive alignment and optical connection between nanowaveguides and optical fibers 204 (or the fiber cores 206 thereof) is improved. As demonstrated in FIG. 2, a fiber core 206 can be aligned with the increased cross-sectional area provided by a mode converter 208. Technical benefits resulting from the use of the mode converters 208 include improved production yields, increased misalignment tolerance, decreased loss between fibers and a device, decreased attachment cost, faster alignment and production, and decreased device failures

FIG. 3 illustrates another partial side view of an example photonic device 200. A plane of the partial side view shown in FIG. 3 is parallel with a length of a V-groove 202 of the photonic device 200. For example, the partial side view of FIG. 3 is a portion of a cross-section of the photonic device 200 along the V-groove 202.

In the illustrated example, an optical fiber 204 sits within a V-groove 202 that extends through an oxide layer 212 of the photonic device 200 into a substrate layer 210. In the illustrated example, an end of the optical fiber 204 (e.g., facing the photonic device 200) is tapered. However, it will be appreciated that other examples of optical fibers that sit within the V-groover 202 may not include tapered ends, and that the illustrated example should not be construed as limiting.

A nanowaveguide 214 is located at a terminal end of the V-groove 202, and a mode converter 208 is located between the end of the nanowaveguide 214 and the end of the optical fiber 204, and surrounds the end of the nanowaveguide 214 that protrudes into the V-groove 202. In particular, in some embodiments, the nanowaveguide 214 is located within the mode converter 208 or within the oxide layer 212 such that oxide material is both above and below the nanowaveguide 214. Thus, the mode converter 208 provides an interface or a bridge at which respective optical modes of the nanowaveguide 214 and the optical fiber 204 are matched, and at which the optical fiber 204 is physically attached to the photonic device 200. With the oxide material surrounding the nanowaveguide 214, mode matching or coupling is improved. As illustrated, the nanowaveguide 214 and the mode converter 208 protrude into the V-groove 202. In some embodiments, the mode converter is an oxide taper, and the end of the nanowaveguide 214 is also tapered.

In some embodiments as illustrated in FIG. 3, the nanowaveguide 214 extends within a length of the mode converter 208 that is past a starting point of the V-groove. As such, the nanowaveguide 214 also protrudes into the V-groove 202. By protruding into the V-groove 202, the nanowaveguide 214 and the mode converter 208 are suspended above the V-groove 202, without substrate material being adjacent to the end of the nanowaveguide 214 and the mode converter. By doing so, an amount of light that leaks out to the substrate is reduced, and adiabatic mode conversion is facilitated. In some embodiments, a terminal end of the nanowaveguide 214 does not reach the terminal end of the mode converter 208. That is, a distance exists between the respective ends of the nanowaveguide 214 and the mode converter 208. In such embodiments, the end of the nanowaveguide 214 may terminate within the mode converter 208 to enable the mode matching or coupling with the optical fiber 204.

The illustrated example in FIG. 3 shows the mode converter 208 being a feature of the oxide layer along the length of the nanowaveguide 214. In some other embodiments, the mode converter 208 is only located near the end of the nanowaveguide 214 to convert the mode of light emitted at the end of the nanowaveguide 214. Thus, in some embodiments, the mode converter 208 is not reliant upon a presence of the cladding oxide layer and can be included in a photonic device 200 without necessarily being connected to or requiring the cladding oxide layer.

The illustrated example demonstrates an optical fiber 204 sitting in the V-groove 202 to be aligned with the mode converter 208. In particular, the illustrated example depicts the optical fiber 204 and the photonic device 200 at a pre-fusion state, where the optical fiber 204 has not been fused to the photonic device 200. In some embodiments, subsequent to aligning the optical fiber 204 in the V-groove with the mode converter 208, the optical fiber 204 is fused (e.g., via laser light, via optical adhesives, and/or the like) with the photonic device 200 at the mode converter 208.

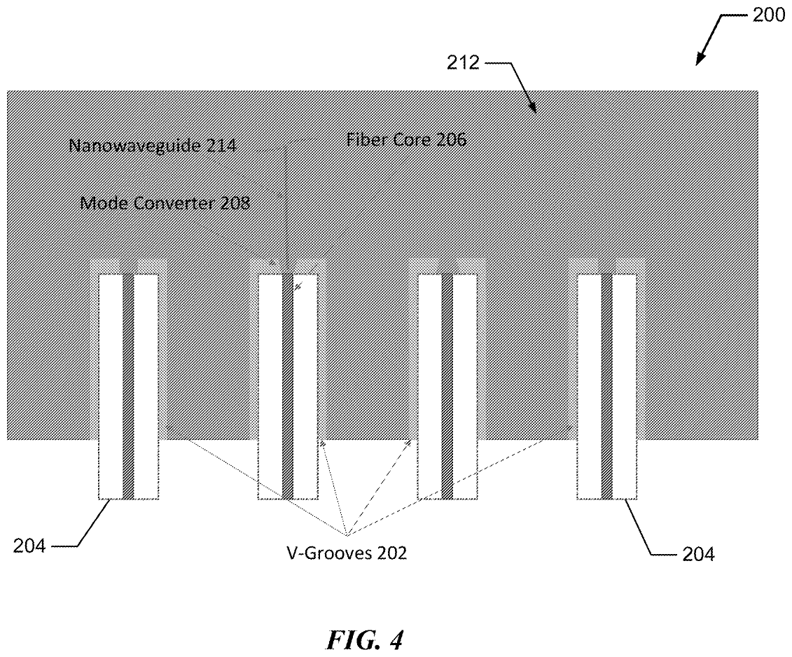

FIG. 4 illustrates a top view of a portion of an example photonic device 200.

The oxide layer 212 of the photonic device 200 is shown according to the top view. For example, the oxide layer 212 is a cladding layer of the photonic device 200. As illustrated, the photonic device 200 includes a plurality of V-grooves 202 that are etched into the oxide layer 212 and a substrate of the photonic device 200. Mode converters 208 are located at respective ends of the V-grooves 202, and the mode converters 208 provide a prominent connection point at which the optical fibers are physically and optically connected with the photonic device 200. As such, an optical fiber 204 that deviates from an intended position within a V-groove 202 to an extent can still be aligned to provide an optical connection with the photonic device 200.

In some embodiments, the mode converters 208 are tapered features of the oxide layer 212, and a mode converter 208 can be tapered in various taper types or shapes, including straight taper (tapers illustrated at far left and far right sides in FIG. 4), inverse or inverted horn taper (third taper from left in FIG. 4), horn taper (second taper from left in FIG. 4), and/or other types, depending on the application. In some embodiments, the taper type of the mode converter 208 is selected based on a material of the mode converter 208.

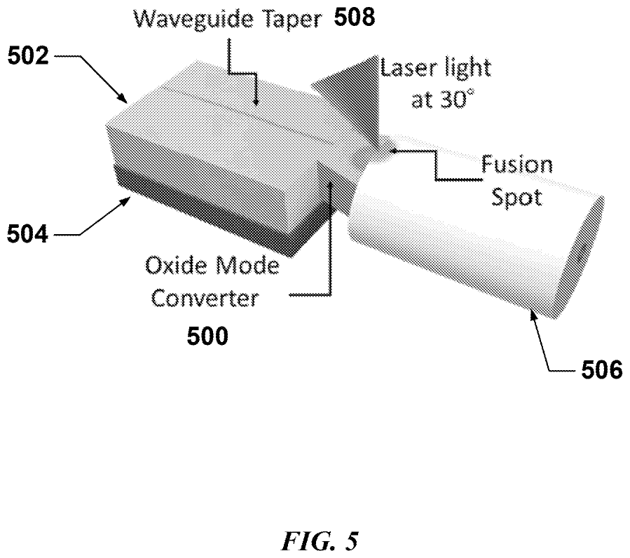

FIG. 5 illustrates a diagram of a perspective view of an example oxide mode converter 500, or a mode converter that is a tapered feature of the oxide layer 502 of a photonic device (the groove of the photonic device and alignment between fiber core, mode converter, and waveguide not explicitly shown or demonstrated).

The oxide mode converter 500 is a mode converter embodied by a tapered feature of the oxide layer 502 of a photonic device. The oxide layer 502 from which the oxide mode converter 500 protrudes overlays a substrate 504 of the photonic device.

In some embodiments, the nanowaveguide of the photonic device that the oxide mode converter 500 optically couples to an optical fiber 506 is a tapered nanowaveguide 508.

In some embodiments, the optical fiber 506 is fused to the oxide mode converter 500 to secure the physical and optical connection. In the illustrated embodiment, laser light impacts a fusion spot at the intersection of the oxide mode converter 500 and the optical fiber 506 to cause fusing of the optical fiber 506 to the oxide mode converter 500 (to the photonic device). In some embodiments, the laser light is between 20 and 50 degrees Celsius, between 25 and 40 degrees Celsius, between 28 and 35 degrees Celsius, or approximately 30 degrees Celsius.

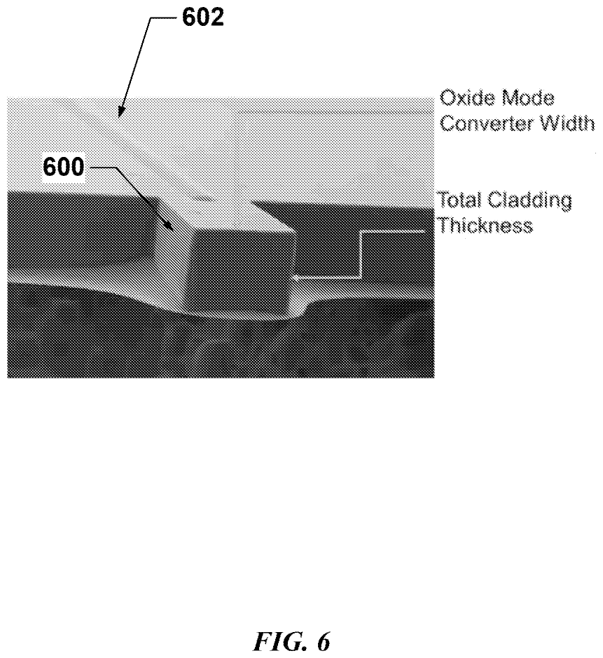

FIG. 6 illustrates an image of an example mode converter 600. The image in FIG. 6 is a scanning electron microscopy (SEM) image.

The mode converter 600 is approximately co-located with a nanowaveguide 602 of a photonic device from the perspective of a V-groove and an optical fiber sitting in the V-groove. For example, the mode converter 600 extends from an end of the nanowaveguide 602. In the provided image, the mode converter 600 is an approximately box-shaped feature protruding from an oxide layer of the photonic device into a V-groove.

In some embodiments, the mode converter 600 is fabricated with a particular width. For example, the width of the mode converter 600 is determined based on a desired taper type and/or based on desired mode matching capabilities and parameters.

In some embodiments, the mode converter 600 is fabricated with a particular thickness, for example a total cladding thickness. In some embodiments, the mode converter 600 has a thickness that is the thickness of the oxide layer of a photonic device.

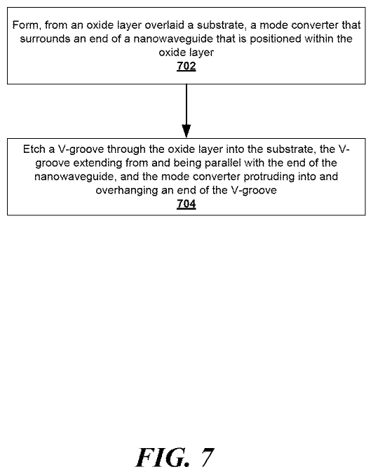

FIG. 7 is a flowchart of example operations for producing an example photonic device. In particular, the photonic device is produced (e.g., fabricated) according to the flowchart of FIG. 7 to include improved passive alignment and optical connection with optical fibers.

At 702, a mode converter is formed from an oxide layer that is overlaid a substrate. The mode converter is formed to surround an end of a nanowaveguide that is positioned within the oxide layer. In some embodiments, the mode converter is formed based on depositing or growing oxide material. In some embodiments, the mode converter is formed based on an etching of the oxide layer.

At 704, a V-groove is etched into a substrate of the photonic device. The V-groove is etched such that the mode converter protrudes into the V-groove. By nature of protruding into the V-groove, the mode converter is suspended at a height within or above the V-groove. In some embodiments, the V-groove is chemically wet etched.

In some embodiments, production of an example photonic device further includes positioning an optical fiber within the V-groove. In some embodiments, positioning the optical fiber includes aligning a fiber core of the optical fiber with the mode converter. By positioning the optical fiber within the V-groove, the optical fiber is aligned with the mode converter and the nanowaveguide that the mode converter surrounds. In some embodiments, the optical fiber is part of a fiber array that is positioned within a plurality of V-grooves.

In some embodiments, production of an example photonic device further includes fusing an optical fiber with the mode converter, the optical fiber being aligned with the mode converter via the V-groove. For example, the optical fiber, after being positioned within the V-groove, is fused with the mode converter located at the end of the V-groove. In some embodiments, the optical fiber and the mode converter are fused using laser light. In some embodiments, optical adhesives are used in fusing the optical fiber with the mode converter.

Following fusion of the optical fiber, performance testing of the photonic device can be performed. As discussed, the mode converter improves optical connection (via mode matching) and performance of the photonic device. With reduced link loss, the photonic device is more likely to pass testing thresholds. Thus, according to the flowchart provided in FIG. 7, production yield of photonic devices is improved.

Some example technical solutions implemented by example embodiments are listed below.
1: A photonic device including a substrate and an oxide layer overlaid the substrate, the photonic device including: one or more nanowaveguides configured for transmission of optical signals to or from the photonic device; one or more V-grooves, each V-groove configured to allow placement of an optical fiber in coarse alignment with a corresponding nanowaveguide; and one or more mode converters, each mode converter formed within and as part of the oxide layer and surrounding an end of the nanowaveguide that protrudes into a corresponding V-groove end. Each mode converter is configured to couple a transverse optical mode of the nanowaveguide to a transverse optical mode of an optical fiber positioned within the V-groove, and a cross-sectional area of each nanowaveguide is smaller than a cross-sectional area of a fiber core of a corresponding optical fiber.
2: The photonic device of solution 1, further comprising the optical fibers positioned in the V-groove. The V-groove is configured to align a fiber core of the corresponding optical fiber within a cross-section of the corresponding mode converter.
3: The photonic device of any of solutions 1-2, wherein at least one of the optical fibers is fused to the mode converter.
4: The photonic device of any of solutions 1-3, wherein at least one of the optical fiber is a single-mode fiber.
5: The photonic device of any of solutions 1-4, wherein at least one of the mode converter protrudes from the oxide layer into the corresponding V-groove.
6: The photonic device of any of solutions 1-5, wherein the one or more mode converters include a tapered mode converter having one of: a straight taper type, a horn taper type, or an inverted horn taper type.
7: The photonic device of any of solutions 1-6, wherein the one or more mode converters include a tapered mode converter having a rectangular or a trapezoidal cross-sectional shape.
8: The photonic device of any of solutions 1-7, wherein the substrate is formed of a silicon material.
9: The photonic device of any of solutions 1-8, wherein the cross-sectional area of at least one of the mode converters is smaller than a cross-sectional area of the corresponding optical fiber.
10: A method for fabricating the photonic device of any of solutions 1-9.
11: Devices and systems for implementing the method of solution 10.
12: A method for producing a photonic device, the method comprising: forming, from an oxide layer overlaid a substrate, a mode converter that surrounds an end of a nanowaveguide that is positioned within the oxide layer; and etching a V-groove through the oxide layer into the substrate. The V-groove extends from and is parallel with the end of the nanowaveguide. A portion of the oxide layer that forms the mode converter protrudes into and overhands an end of the V-groove.
13: The method of solution 12, further comprising positioning an optical fiber within the V-groove, wherein positioning the optical fiber includes aligning a fiber core of the optical fiber with the mode converter.
14: The method of solution 13, wherein aligning the fiber core includes aligning the fiber core with a rectangular or trapezoidal cross-section of the mode converter.
15: The method of any of solutions 12-14, further comprising fusing an optical fiber with the mode converter, wherein the optical fiber is aligned with the mode converter via the V-groove.
16: The method of any of solutions 12-15, wherein etching the V-groove includes chemically wet etching the V-groove.
17: The method of any of solutions 12-16, wherein forming the mode converter includes forming an oxide taper that is one of a straight taper type, a horn taper type, or an inverted horn taper type.
18. A photonic device comprising: a nanowaveguide configured for transmission of optical signals to or from the photonic device; a groove located at an edge of the photonic device, wherein a terminal end of the nanowaveguide is suspended within the groove; and a mode converter coupled to the terminal end of the nanowaveguide such that the mode converter is disposed between the terminal end of the nanowaveguide and an optical fiber received in the groove.
19. The photonic device of solution 18, further comprising the optical fiber, wherein the optical fiber is fused to the mode converter.
20. The photonic device of any of solutions 18-19, wherein the mode converter is formed as a continuous portion of an oxide layer of the photonic device.
21. The photonic device of any of solutions 18-20, wherein the terminal end of the nanowaveguide and a fiber core of the optical fiber are not aligned in at least one dimension, and wherein the fiber core and the mode converter are aligned in the at least one dimension.
22. The photonic device of any of solutions 18-21, wherein the mode converter is configured to
23. The photonic device of any of solutions 18-22, wherein the groove is a V-groove.
24. The photonic device of any of solutions 18-23, wherein the optical fiber is a single-mode fiber.
25. The photonic device of any of solutions 18-24, wherein the mode converter being coupled to the terminal end of the nanowaveguide is also suspended within the groove.
26. The photonic device of any of solutions 18-25, wherein the mode converter is coupled to the terminal end of the nanowaveguide such that the terminal end is enveloped by the mode converter.
27. The photonic device of any of solutions 18-26, wherein the mode converter is a tapered mode converter having one of: a straight taper type, a horn taper type, or an inverted horn taper type.
28. The photonic device of any of solutions 18-27, wherein the mode converter includes a tapered mode converter having a rectangular or a trapezoidal cross-sectional shape.
29. The photonic device of any of solutions 18-28, wherein the groove is etched into a substrate of the photonic device, the substrate formed of a silicon material.
30. The photonic device of any of solutions 18-29, wherein a cross-sectional area of the mode converter is smaller than a cross-sectional area of the optical fiber.

This patent document incorporates by reference U.S. Pat. No. 10,976,495 titled “SYSTEM AND METHOD FOR ATTACHING OPTICAL FIBERS TO CHIPS” filed on Jan. 18, 2018, and U.S. patent application Ser. No. 17/016,768 titled “SYSTEM AND METHOD FOR ATTACHING OPTICAL FIBERS TO CHIPS” filed on Sep. 10, 2020. The identified patent and application are incorporated herein by reference in their entireties, except for any subject matter disclaimers or disavowals, and except to the extent that the incorporated material is inconsistent with the express disclosure herein, in which case the language In this disclosure controls. Aspects of the presently disclosed technology can be modified to employ the systems, functions, and concepts of the various references described above to provide yet further implementations of the invention.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the singular forms “a”, “an” and “the” are intended to include the plural forms as well, unless the context clearly indicates otherwise. Additionally, the use of “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. A photonic device including a substrate and an oxide layer overlaid the substrate, the photonic device comprising:
one or more nanowaveguides configured for transmission of optical signals to or from the photonic device;
one or more V-grooves, each V-groove configured to allow placement of an optical fiber in coarse alignment with a corresponding nanowaveguide; and
one or more mode converters, each mode converter formed within and as part of the oxide layer and surrounding an end of the nanowaveguide that protrudes into a corresponding V-groove end, wherein each mode converter is configured to couple a transverse optical mode of the nanowaveguide to a transverse optical mode of an optical fiber positioned within the corresponding V-groove, and wherein a cross-sectional area of each nanowaveguide is smaller than a cross-sectional area of a fiber core of a corresponding optical fiber.

2. The photonic device of claim 1, further comprising the optical fibers positioned in the V-groove, wherein the V-groove is configured to align the fiber core of the corresponding optical fiber within a cross-section of the corresponding mode converter.

3. The photonic device of claim 2, wherein at least one of the optical fibers is fused to the mode converter.

4. The photonic device of claim 2, wherein at least one of the optical fibers is a single-mode fiber.

5. The photonic device of claim 1, wherein at least one of the mode converters protrudes from the oxide layer into the corresponding V-groove.

6. The photonic device of claim 1, wherein the one or more mode converters include a tapered mode converter having one of: a straight taper type, a horn taper type, or an inverted horn taper type.

7. The photonic device of claim 1, wherein the one or more mode converters include a tapered mode converter having a rectangular or a trapezoidal cross-sectional shape.

8. The photonic device of claim 1, wherein the substrate includes a silicon material.

9. The photonic device of claim 1, wherein the cross-sectional area of at least one of the mode converters is smaller than a cross-sectional area of the corresponding optical fiber.

10. A method for producing a photonic device, the method comprising:
forming, from an oxide layer overlaid a substrate, a mode converter that surrounds an end of a nanowaveguide that is positioned within the oxide layer; and
etching a V-groove through the oxide layer into the substrate, wherein the V-groove extends from and is parallel with the end of the nanowaveguide, and wherein a portion of the oxide layer that forms the mode converter protrudes into and overhangs an end of the V-groove.

11. The method of claim 10, further comprising positioning an optical fiber within the V-groove, wherein positioning the optical fiber includes aligning a fiber core of the optical fiber with the mode converter.

12. The method of claim 11, wherein aligning the fiber core includes aligning the fiber core with a rectangular or trapezoidal cross-section of the mode converter.

13. The method of claim 10, further comprising fusing an optical fiber with the mode converter, wherein the optical fiber is aligned with the mode converter via the V-groove.

14. The method of claim 10, wherein etching the V-groove includes chemically wet etching the V-groove.

15. The method of claim 10, wherein forming the mode converter includes forming an oxide taper that is one of a straight taper type, a horn taper type, or an inverted horn taper type.

16. A photonic device comprising:
a nanowaveguide configured for transmission of optical signals to or from the photonic device;
a groove located at an edge of the photonic device, wherein a terminal end of the nanowaveguide is suspended within the groove; and
a mode converter coupled to the terminal end of the nanowaveguide such that the mode converter is disposed between the terminal end of the nanowaveguide and an optical fiber received in the groove.

17. The photonic device of claim 16, further comprising the optical fiber, wherein the optical fiber is fused to the mode converter.

18. The photonic device of claim 16, wherein the mode converter is formed as a continuous portion of an oxide layer of the photonic device.

19. The photonic device of claim 16, wherein the terminal end of the nanowaveguide and fiber core of the optical fiber are not aligned in at least one dimension, and wherein the fiber core and the mode converter are aligned in the at least one dimension.

20. The photonic device of claim 16, wherein the mode converter is configured to match a mode of the nanowaveguide and a mode of the optical fiber.
